(19) United States
(12) Patent Application Publication
(10) Pub. No.: US 2011/0015932 A1
(43) Pub. Date: Jan. 20, 2011

(54) METHOD FOR SONG SEARCHING BY VOICE

(76) Inventors: Chen-Wei SU, Taipei City (TW); Tsung-Han Tsai, Taipei City (TW); Chun-Ping Fang, Taipei City (TW)

Correspondence Address: Muncy, Geissler, Olds & Lowe, PLLC, 4000 Legato Road, Suite 310, FAIRFAX, VA, 22033, US

(21) Appl. No.: 12/554,599

(22) Filed: Sep. 4, 2009

(30) Foreign Application Priority Data
Jul. 17, 2009 (TW) 098124328

(51) Int. Cl. G10L 15/00; G06F 17/00; G06F 17/30

(52) U.S. Cl. 704/275; 700/94; 707/E17.014; 704/E15.001

(57) ABSTRACT

The present invention relates to a method for song searching by voice, especially the method with which users can complete settings and then start searching, so that the users' voices of search conditions will be acquired to make voice recognition, and the recognition results will be compared with the instruction data and song attribute data in the voice recognition database to obtain comparison data. If the comparison data do not correspond with the preset conditions, the next search condition generated from the comparison data will be broadcast with voice, and the users are allowed to speak out the next search condition to make comparisons of search conditions in the next process. If the comparison data correspond with the preset conditions, one or more song files will be read according to the comparison data and will be given a preview. With this method in hand, the users will not touch buttons or knobs by mistake, do not need to spend time in searching for song files one by one, and do not need to free one or both of their hands to press the buttons or knobs, either. Besides, the users can decide on such matters as search conditions, initial position of previews, whether to play immediately after choices are made, preview period, sequential or shuffle play, etc, thus promoting convenience for users in searching for songs and meeting preferences and needs of different users.

This application claims the priority benefit of Taiwan patent application number 098124328 filed on Jul. 17, 2009

### BACKGROUND OF THE INVENTION

1. Field of the Invention

The present invention related to a method for song searching by voice, and more particularly, to a method with which users can complete settings and gain access to file data on songs by themselves, and after the search function is started, users' voices can be acquired to distinguish these songs and conduct data comparison, so as to play the song data derived from data comparison with sound or carry out a preview of songs directly, thus facilitating song searching.

2. Description of the Prior Art

With continuous researches and developments in electronic products, computers, portable music players (e.g. MP3, MP4 or MP5) and other electronic products have been launched by firms in the present days, compared to the past when music was played only by using audio equipments. As these electronic products are more convenient used and equipped with high capacity hard disks inside, these products are originally capable of playing music only based on tapes, CDs and so on as storage media will shift to store song files into hard disks and play the songs directly. Thus, users do not need to replace music storage media when they want to listen to songs in different albums, and do not need to carry or prepare multiple music storage media with them, either. As a result, much storage space will be saved. Besides, with popularity of Internet applications, multimedia audiovisual signals can be transmitted and downloaded through network packets for the purpose of digitalized audiovisual signal transmission, and the audio or video signals downloaded from legitimate websites can be stored into hard disks.

As hard disk capacity increases, users can store more albums in the hard disks. As more albums are stored in these hard disks, however, users have to press or turn buttons frequently before they can listen to the album they want. That is to say, they have to search for the album they want among albums. This way of searching not only requires users to spend a lot of time; in addition, if they forget the name of the song they want to listen to, they must begin with the first song of the album or listen to all albums of the singer, searching inconveniently. In cases when users are unable to operate electronic products manually, for example, when they walk, drive or ride motorcycles, the problem of inconvenience for use is more obvious. Besides, since electronic products become lighter, thinner, shorter and smaller with limited space on their surface in the course of research and development, the buttons or knobs installed on these surfaces also become rather miniaturized, leading to extreme inconvenience in operation, causing wrong pressing or miss choices.

The conventional method for song searching as mentioned above has such many problems and disadvantages, and constitutes what the inventor and those involved in this industry need to research and improve.

### SUMMARY OF THE INVENTION

An object of the present invention is to provide a method for song searching by voice having convenient use and allowing users to make personalized settings.

The primary objective of the present invention is to apply the method for song searching by voice to recognize voices of users, compare the recognition result with instruction data or song attribute data in the voice recognition database, and play the data to be compared directly through speeches or give a preview of the corresponding song files based on the data to be compared, so as to ensure that the users will not touch buttons or knobs by mistake, and save time in searching for song files. Besides, the users do not need to press input devices by hand(s). This will not only promote convenience for users in search for songs, but also enable them to choose the songs they want to listen to even when they cannot press the buttons by hand(s), thus achieving the objectives of searching for songs quickly and free users' hands to conduct other operations in the process of searching.

The another objective of the present invention is to ensure that after programs are initiated, users can set such items as conditions for searching, position to start a preview of songs, sequential play, shuffle play, preview periods and whether to play immediately after choices are made by the users themselves, etc. Since different users have different preferences and needs, this method will generate ways of personalized search setting and previews for the purpose of making it easier for users to operate.

The other objective of the present invention is to acquire song files in accordance with the comparison data and initiate a preview of a song from the proposed starting position after voice recognition is completed and the song is found and compared, allowing users to find the song for which they want to search by listening actually. This will not only reduce the time spent by the users to recall the name of the song, but also help make a preview of songs as a suite, thus generating new experiences of using and sense of listening.

A further objective of the present invention is to enable multimedia electronic devices to show playlists on the display, so that users can adjust the songs to be played by clicking to choose the playlist before they begin a preview of songs. In this way, they can listen to the songs to be played repeatedly and further achieve the purpose of finding the songs they are looking for quickly and accurately.

### BRIEF DESCRIPTION OF THE DRAWINGS

FIG. 1 is a block diagram illustrating an example of the preferred embodiment of the present invention.

FIG. 2 schematically shows settings for the present invention.

FIG. 3 is a flow chart illustrating an example of the preferred embodiment of the present invention.

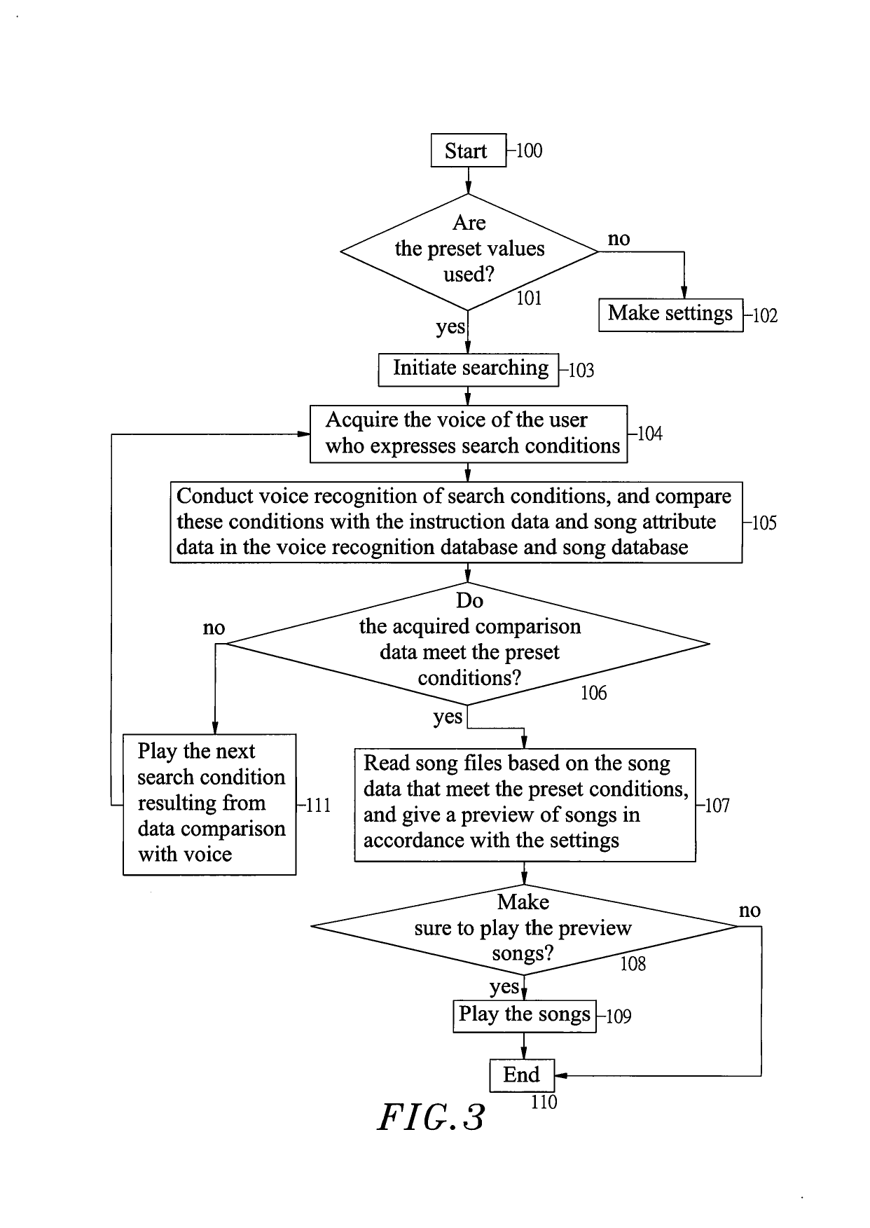

FIG. 4 is a block diagram illustrating another example of the preferred embodiment of the present invention.

### DETAIL DESCRIPTION OF THE INVENTION

In order to achieve the aforesaid objectives and effects as well as the technology adopted in the present invention and its structure, the following example of the preferred embodiment of the present invention is given to illustrate its features and functions in detailed with reference to the accompanying drawings for better understanding.

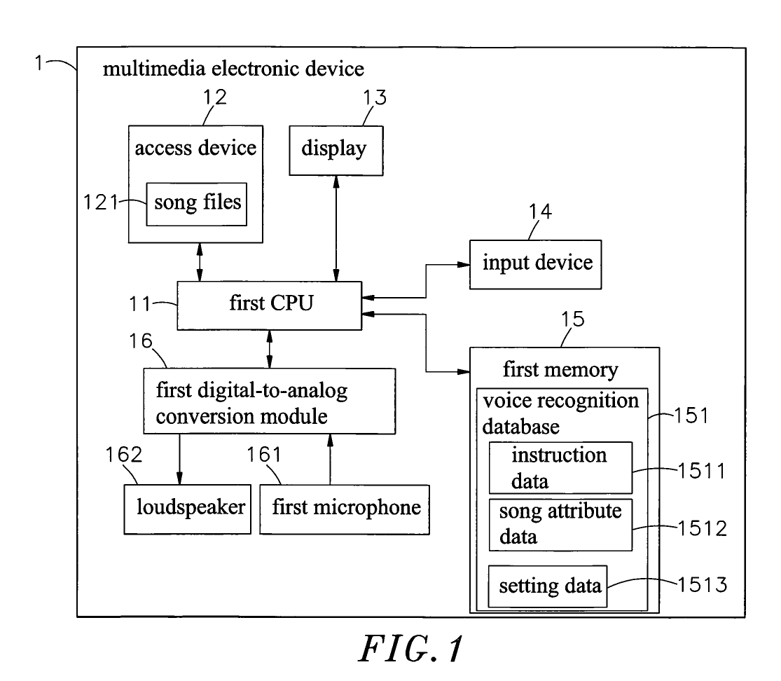

Refer to FIG. 1, which is a block diagram illustrating an example of the preferred embodiment of the present invention. As shown clearly in this figure, the method for song searching by voice is applied in a multimedia electronic device 1 equipped with a first central processing unit (CPU) 11, which is electrically connected with an access device 12 that stores a plurality of song files 121, a display 13, an input device 14, a first memory 15 and a first digital-to-analog conversion module 16 respectively. Inside the first memory 15, there is a voice recognition database 151 which contains instruction data 1511, song attribute data 1512 and setting data 1513, and the first digital-to-analog conversion module 16 is electrically linked with a first microphone 161 and a loudspeaker 162. The multimedia electronic device 1 may or may not be equipped with the display 13, which shall not be limited herein.

For use of the multimedia electronic device 1, the first CPU 1 will execute programs stored in the access device 12 and open the setting page for users to set search conditions, or acquire all song file data (ID3 Tag) in the access device 12 and store these data into the first memory 15 to form the song attribute data 1512 in the voice recognition database 151. The search conditions cover such proposed items as all singers, albums, playlists, names of singers, names of albums, names of playlists, etc., and each of these items can be followed by further search conditions. In addition, users can set such items as the initial position of previews, repeat, shuffle play, preview period and whether to start play immediately after the users make choices. After the settings are completed, the setting information will be stored into the setting data 1513 of the voice recognition database 151 in the first memory 15, in which the voice recognition database 151 is additionally stored. The voice recognition database 151 has the instruction data 1511 that contains general instructions (for example, forward play, backward play, pause, play, searching for singer, searching for album, searching for playlist, etc.), and includes the song attribute data 1512 that contains all song files.

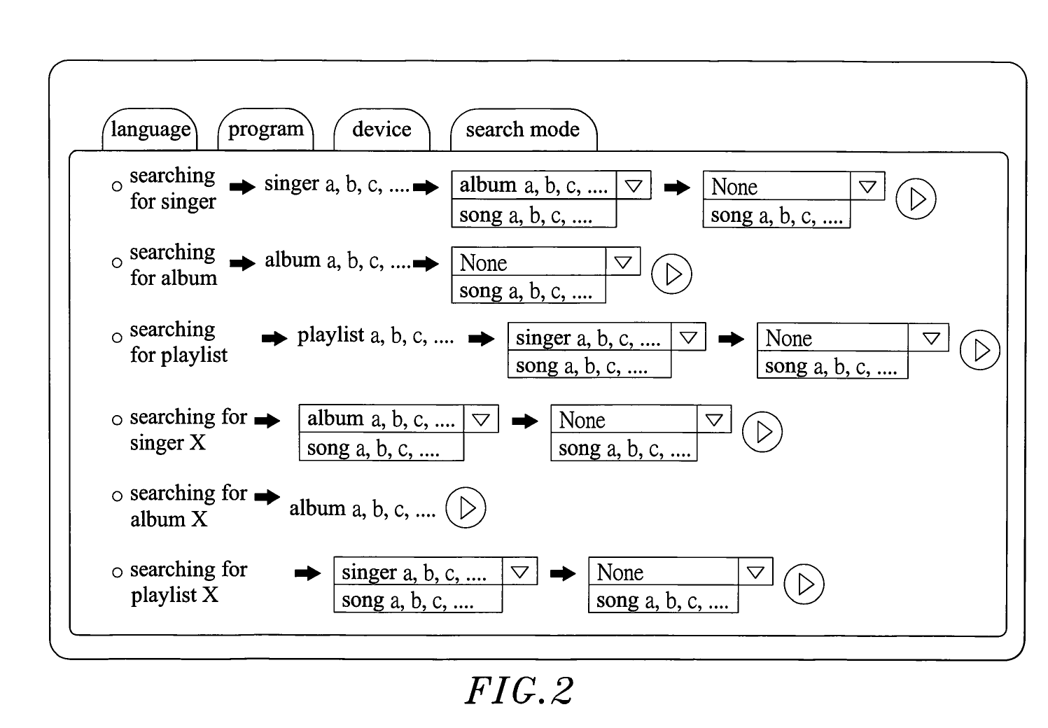

Refer to FIG. 2, which schematically shows settings for the present invention. There are totally six search conditions to be set. For example, only the item of searching of singer can be followed by settings on searching of name of singer, album or of song in sequence, or the follow-up conditions for searching of singer are set as searching of singer's name and searching of song name, so that users can directly search more songs for song names according to their preferences following searches for singer names; or under the condition of searching of singer name, search for the album name first, and then search for the song name to conduct more accurate searching for songs of a smaller number; only under the item of searching for album, users can make settings on searching of album name, which may be followed by searching of song name or no search condition; searching of playlist goes after searching of playlist name, and then users can select to make settings on searching of name of singer, album or song, or no search condition in sequence. If the first condition for this item involves searching of name of singer, album or playlist, following settings can be made in the same way as done above. The aforesaid search condition settings may vary with the year, record companies, languages, etc., as long as these settings enable desired songs to be identified by comparing and searching a plurality of songs by voice, and shall not be limited herein. It is hereby stated that other modifications and equivalent structural changes made without departing from the art and spirit of the present invention shall be included in the appended claims of the present invention.

Refer to FIGS. 1˜3, which are respectively a block diagram, a schematic drawing of settings and a flow chart illustrating an example of the preferred embodiment of the present invention. As shown clearly in these figures, the multimedia electronic device 1 implements voice search according to the steps as follows:
(100) Start.
(101) Are the preset values used? If yes, proceed to step (103); otherwise, proceed to step (102).
(102) Make settings.
(103) Initiate searching.
(104) Acquire the voice of the user who expresses search conditions.
(105) Conduct voice recognition of search conditions, and compare these conditions with the instruction data and song attribute data in the voice recognition database.
(106) Do the acquired comparison data meet the preset conditions? If yes, proceed to step (107); if not, proceed to step (111).
(107) Read song files based on the song data that meet the preset conditions, and give a preview of songs in accordance with the settings.
(108) Make sure to play the preview songs? If yes, proceed to step (109); otherwise, proceed to step (110).
(109) Play the songs.
(110) End.
(111) Play the next search condition resulting from data comparison with voice, and proceed to step (104).

It can be seen from the above steps that users can utilize the preset values or make settings by themselves. When making settings by themselves, users can set the next search condition after a given search condition for every item of search conditions. In the case of searching for name of singer, for example, users can set the subsequent search conditions to be the name of the album and the name of the song in order, or directly search for the name of the song; when searching for the name of the album, users can set the subsequent search conditions to be the name of the song, or just no further condition. Under items of the aforesaid search conditions, users can rely on the given search conditions or select search conditions by themselves, and can set loose search conditions to strict search conditions in order among name of playlist, name of singer, name of album, name of song and no setting. However, users can skip over loose search conditions to make settings of strict search conditions directly, as long as these conditions can narrow down the search range to satisfy users' preferences and enable them to find the songs they want, and this shall not be limited herein. It is hereby stated that all other modifications and equivalent structural changes made without departing from the art and spirit of the present invention shall be included in the appended claims of the present invention.

Additionally, since it is possible that users store a plurality of new song files 121 in the access device 12, the function of synchronously acquiring data of the song files 121 can be initiated in the setting page. Then the first CPU 1 will once again acquire the data of all song files 121 from the access device 12 and store these data as the song attribute data 1512 in the voice recognition database 151 of the first memory 15. If the users do not acquire the data of the song files 121 once again, the first CPU 1 will only make a comparison of the song attribute data 1512 that have been stored in the first memory 15 when the search function is started.

Users shall press the input device 14 or directly use their voices to start searching. After recognition, the voices will be compared with the instruction data 1511 in the voice recognition database 151 to start searching directly. At this moment, the first CPU 11 will read the preset voice data (the instruction data 1511 or song attribute data 1512) in the first memory 15, and convert these digital data into analog data through the first digital-to-analog conversion module 16, and then use the loudspeaker 162 to broadcast these analog data. After having heard the voices, users can speak out the items of search conditions to the first microphone 161, which will acquire these voices, and the first digital-to-analog conversion module 16 will convert the analog data of these voices into digital data, which will be transmitted to the first CPU 11. The first CPU 11 will implement voice recognition of these digital data, and then compare the results from the voice recognition with the instruction data 1511 or song attribute data 1512 in the voice recognition database 151 of the first memory 15 to obtain comparison data (such as names of singers, albums or songs). If the further search condition for the comparison data is name of singer or name of album, since the comparison result does not meet the preset requirement (name of song), the first CPU 11 will directly send a signal through the first digital-to-analog conversion module 16 to the loudspeaker 162 to play a further search condition (name of singer and name of album). And the first CPU 11 will proceed to the next search condition after it again reads the steps of the search condition for the setting data 1513 in the first memory 15. If the comparison data are song names, the first CPU 11 will again acquire one or more song files 121 that meet the set conditions from the access device 12 based on comparison of song data, and execute previews of songs according to the set conditions. However, the aforesaid voice recognition for conventional use is a prior art, and is not described in more detail, since this detailed composition is not a major point of the present invention.

After the loudspeaker 162 plays the acquired data files, such as singer name or album name, etc, users can directly press the input device 14. After having received the signals from the device, the first CPU 11 will acquire one or more song files 121 that meet the set conditions from the access device 12 and play these files. If the users speak out the next search condition, the first CPU 11 will initiate recognition and make comparisons for a second time.

If the comparison data are song names, the loudspeaker 162 will make a preview of one or more song files 121 that correspond with the song data. At this time, the first CPU 11 will acquire the setting data 1513 from the first memory 15 to conduct sequential or shuffle previews of all songs, and can start previews of songs from the set initial position according to the set data (for example, if the initial position is set to be 2 minutes and 50 seconds, all songs will be played from the point of 2 minutes and 50 seconds). After the songs are played to the preview time of the setting data 1513, the next song will be played. In this way, users can select the songs they want to hear by listening to song previews when they forget names of songs or albums, and even achieve the effect of playing a plurality of songs continuously as a suite. In addition, if the first CPU 11 is electrically connected with the display 13, the playlist of the plurality of the songs will be shown in the display 13, and users can click to choose the playlist by using the input device 14 to adjust previews of songs. If the users want to listen to the songs that have been played for a second time, they can click to choose the playlist and listen to these songs again, thus making sure if these songs are those they want to hear by listening to them again. Since they listen instead of searching again, the effect of finding the songs they want to hear quickly and accurately will be achieved.

Besides, as most of car audio devices are usually operated by using buttons, knobs or touch screens, if drivers want to adjust or find the song they want to hear when they are driving, they must turn their eyes on and put one of their hands to the panel. Since the drivers avert their sight, it is likely to cause car accidents in case of emergency situations due to slowness in reacting or inflexibility in steering their cars with one hand. If the present invention is applied in car audio equipments, it will enable drivers to focus their attention on roads and put both hands on the steering wheel, thus enhancing safety in driving.

The multimedia electronic device 1 for using in the method for song searching by voice may be a computer or car audio device, or may also be a portable multimedia electronic device.

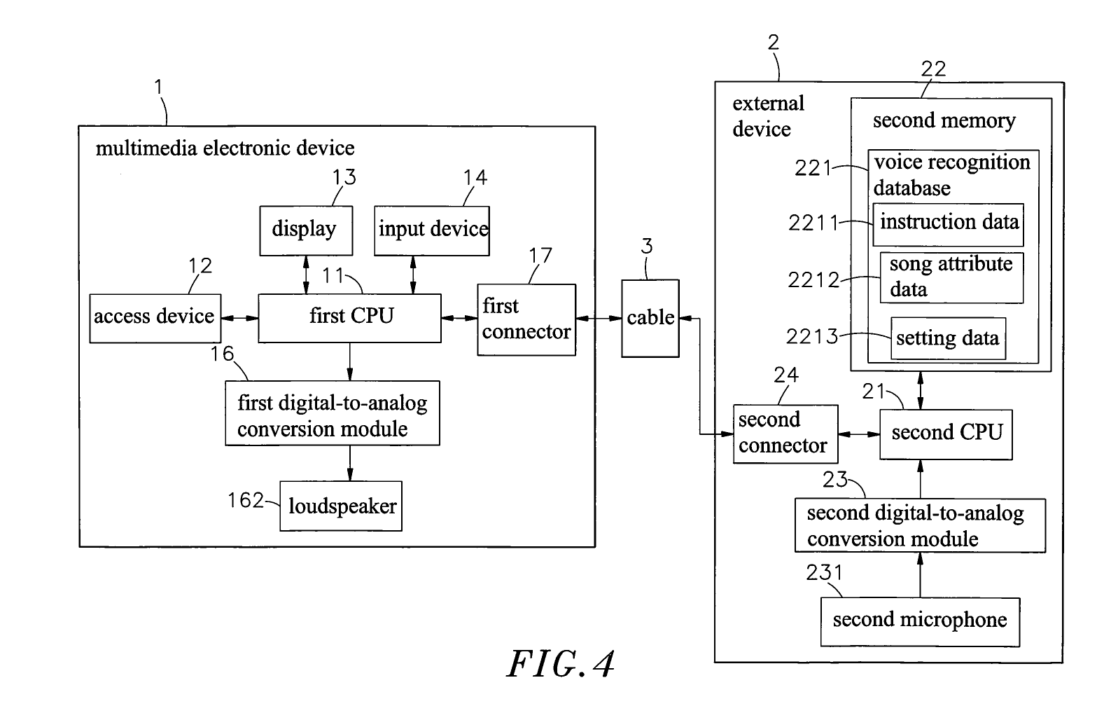

Refer to FIG. 4, which is a block diagram illustrating another example of the preferred embodiment of the present invention. Alternatively, if the multimedia electronic device 1 is the portable multimedia electronic device, the multimedia electronic device 1 includes a first CPU 11, a access device 12, a display 13, an input device 14, a first digital-to-analog conversion module 16 and a first connector 17 and the first CPU 11 is connected electrically with an access device 12, a display 13, an input device 14, a first digital-to-analog conversion module 16 and a first connector 17 respectively, wherein the first digital-to-analog conversion module 16 is electrically connected with a loudspeaker 162. In addition, the multimedia electronic device 1 is electrically linked with an internal device 2, in which the second CPU 21 is electrically connected with a second memory 22, a second digital-to-analog conversion module 23 and a second connector 24. The second CPU 21 has a voice recognition database 221 that includes instruction data 2211, song attribute data 2212 and setting data 2213, while the second digital-to-analog conversion module 23 is electrically connected with a second microphone 231. Then the first connector 17 of the multimedia electronic device 1 is electrically plugged into the second connector 24 of the external device 2, or a cable 3 is used to connect the first connector 17 with the second connector 24, so that the multimedia electronic device 1 is electrically connected with the external device 2.

For use of the multimedia electronic device 1 and external device 2 (FIG. 4), the first CPU 11 reads programs and a plurality of song files 121 in the access device 12, and makes the loudspeaker 162 to play voices or songs by using the first digital-to-analog conversion module 16. Then it reads all song files 121 in the access device 12 and transmits these files through the first connector 17 to the second connector 24 of the external device 2 and further to the second CPU 21, which will store the data of all song files 121 into the song attribute data 2212 of the voice recognition database 221 in the second memory 22. Users can press the input device 14 of the multimedia electronic device 1 to start searching, and use the second microphone 231 of the external device 2 to acquire voices, which will be converted by the second digital-to-analog conversion module 23 into data and compared with the instruction data 2211 or song attribute data 2212 of the voice recognition database 221 in the second memory 22. If the comparison data are singer names and album names, the second CPU 21 will transmit these data to the first CPU 11 through the second connector 24 and first connector 17, so that the first CPU 11 directly sends the obtained singer names or album names through the first digital-to-analog conversion module 16 to the loudspeaker 162 for speaking. If the comparison data are song names, the second CPU 21 will transmit these data through the second connector 24 and first connector 17 to the first CPU 11, which will acquire one or more song files 121 that meet the set conditions from the access device 12 according to the song data to be compared, and then make a preview of songs directly by using the first digital-to-analog conversion module 16 and loudspeaker 162. For a next search condition, the second CPU 21 reads the steps of the search conditions for the setting data 2213 in the second memory 22, and then transmits these steps to the first CPU 11 for processing. This allows the multimedia electronic device 1 originally unable to search for songs by voice to have the function of song searching by voice by using the external device 2 that is connected with it.

In practical applications, the method for song searching by voice as disclosed in the present invention has the advantages as follows:

(1) The method for song searching by voice is based on voice recognition to compare the voices with the instruction data 1511 and song attribute data 1512 of the voice recognition database 151, and play voices directly based on the comparison data, or acquire one or more song files 121 that correspond with the comparison data for a preview. Nowadays as users store more and more song files 121 in the access device 12, with this method in hand, they do not need to search many song files 121 one by one for what they want, and will not touch buttons or knobs by mistake due to small size of these buttons or knobs. As a result, this method will facilitate searching for songs.
(2) The method for song searching by voice is based on voices for song searching, so users do not need to free one of their hands to press the input device 14. Therefore, this method enables them to do other things with both of their hands while searching for songs, and allows them to listen to the songs they want even if they cannot free their hands to press the input device 14.
(3) The method for song searching by voice enables users to complete settings on search conditions, initial positions of song previews, sequential play, shuffle play, preview period and whether to play immediately after they make choices by themselves when the program is started, and allows the users to store these settings as the setting data 1513, thus ensuring that the search settings correspond with preferences and needs of different users.
(4) The method for song searching by voice enables acquisition of the song files 121 from the access device 12 in accordance with the comparison data, and enables songs to be played from the set initial position of song preview. Therefore, it not only allows users to find the songs they want to hear under the condition that song names are unknown, but also plays a plurality of songs as a suite.
(5) In case of song previews by using the method for song searching by voice, if the multimedia electronic device 1 is electrically connected with the display 13 via the first CPU 11, the playlists will be displayed on the display 13, and users can click to choose the playlists directly on the display 13 or through the input device 14 to adjust the songs of preview, and make sure of the songs by repeating the preview song instead of searching for a second time.

Therefore, the present invention mainly relates to a method for song searching by voice, and enables users to start searching and acquire their voices for recognition after they complete settings and acquire the song files 121. It allows playing the song attribute data 1512 derived from data comparison or previews of songs to promote convenience in searching for songs as a major point of protection.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A method for song searching by voice, the method with which users can make multimedia electronic devices search for songs by using their voices, comprising the steps of:
(1) starting;
(2) existing the preset values or not, if yes, proceed to step (4); otherwise, proceed to step (3);
(3) setting by users; the settings include priority, number and type of steps for search conditions, which cover singer, album, playlist, singer name, album name and playlist name, and these settings will be stored as the setting data;
(4) initiating searching;
(5) acquiring the voices of the users who express search conditions;
(6) conducting voice recognition of the search conditions, and comparing them with instruction data and song attribute data in the voice recognition database;
(7) comparing the acquired comparison data and the preset conditions are the same or not, if yes, proceed to step (8); if not, proceed to step (11);
(8) reading song files based on the song data that meet the preset conditions, and give a preview of songs in accordance with the settings;
(9) playing the preview songs or not? If yes, proceed to step (10); otherwise, proceed to step (11);
(10) playing the song;
(11) ending;
(112) playing the next search condition resulting from data comparison with voice, and proceed to step (5).

2. The method for song searching by voice according to claim 1, wherein before the step of playing the song, the song attribute data can be played first.

3. The method for song searching by voice according to claim 1, wherein the step of setting by users is that the users may select to acquire data of all song files (ID3 Tag) and store these data in the voice recognition database as the song attribute data.

4. The method for song searching by voice according to claim 1, wherein the settings include initial positions of song previews, sequential play, shuffle play, preview period and whether to play immediately after choices are made, and store these settings as the setting data; so that the multimedia electronic devices can give sequential or shuffle previews of songs based on the setting data, start song previews from the set initial position and continue to give a preview of another song when the time set for song previews is over.

5. The method for song searching by voice according to claim 1, wherein the voice recognition database has the instruction data that cover such instructions as forward play, backward play, pause, play, searching for singer, searching for album and searching for playlist.

6. The method for song searching by voice according to claim 1, wherein before the step of acquiring the voices of the users who express search conditions, the users can play the preset voice data of search conditions to be executed by using voices before they speak out these search conditions.

7. The method for song searching by voice according to claim 1, wherein the step of playing the preview songs the playlists are indicated for the users to control and adjust playing of songs.

8. The method for song searching by voice according to claim 1, wherein the preset condition is song names.

9. A method for song searching by voice, more particularly, the method with which users can make multimedia electronic devices search for songs by using their voices, wherein searching is started to acquire the users' voices that include search conditions after they make settings, and these search conditions will be compared with instruction data and song attribute data in the voice recognition database following voice recognition; the comparison data derived in this process will be used to make further comparisons, until the comparison data of song names are obtained; and then the comparison data of song names will be used to read song files and give a preview of these songs files, thus enabling the users to set search conditions by themselves and search for songs by listening to these songs.

10. The method for song searching by voice according to claim 10, wherein the settings can be priority, number and type of steps for search conditions or directly use the default values, and the search conditions may cover singer, album, playlist, singer name, album name and playlist name, and these settings will be stored as the setting data upon completion.

11. The method for song searching by voice according to claim 10, wherein before playing the preview songs, the song attribute data can be played.

12. The method for song searching by voice according to claim 10, wherein the setting is that select to acquire data of all song files (ID3 Tag) and store these data into the voice recognition database as the song attribute data when they make settings

13. The method for song searching by voice according to claim 10, wherein the settings include initial positions of song previews, sequential play, shuffle play, preview period and whether to play immediately after choices are made when they make settings by themselves, and store these settings as the setting data; so that the multimedia electronic devices can give sequential or shuffle previews of songs based on the setting data, start song previews from the set initial position and continue to give a preview of another song when the time set for song previews is over.

14. The method for song searching by voice according to claim 10, wherein the instruction data of the voice recognition database include forward play, backward play, pause, play, searching for singer, searching for album and searching for playlist.

15. The method for song searching by voice according to claim 10, wherein before speaking out the search conditions, the users can play the preset voice data of search conditions to be executed by using voices.

16. The method for song searching by voice according to claim 10, wherein when playing the preview songs, the playlists can be shown for the users to control or adjust playing of songs.
